(19) United States
(12) Patent Application Publication
(10) Pub. No.: US 2006/0096957 A1
(43) Pub. Date: May 11, 2006

(54) Clamping device for processing work pieces

(76) Inventor: Daniel Pfiz, Niederstotzingen (DE)

Correspondence Address: AKERMAN SENTERFITT, 222 LAKEVIEW AVENUE, SUITE 400, P.O. BOX 3188, WEST PALM BEACH, FL, 33401, US

(21) Appl. No.: 11/092,304

(22) Filed: Mar. 29, 2005

(30) Foreign Application Priority Data
Mar. 29, 2004 (DE) 10 2004 015 250.0

(51) Int. Cl. B23K 26/20

(52) U.S. Cl. 219/121.63; 219/161

(57) ABSTRACT

The invention concerns a clamping device for processing, in particular welding, of work pieces. It is the task of the invention to develop a device for processing work pieces, of which the clamp technique enables a high processing quality and, with respect to the work piece geometry, enables a high flexibility of the process. According to the invention, the clamp device for processing of work pieces comprises at least one first clamp element and at least one second clamp element, between which a work piece is held, wherein a tool is movable relative to the work piece, wherein the first clamp element is in the form of a clamp finger (1, 24) and engages on the side of the work piece (3) which is the side upon which the tool (5) acts, and further, that the second clamp element is in the form of a clamp roller (2) and lies against the work piece (4) on the side opposite to the tool (5).

### BACKGROUND OF THE INVENTION

1. Field of the Invention

The invention concerns the clamping device for processing work pieces according to the pre-characterizing portion of Claim 1.

2. Related Art of the Invention

When joining two or more work pieces by welding with high power intensity, such as during laser welding, electron beam welding or plasma welding, the joint gaps between the work pieces may not exceed permissible widths. In maximal permissible joint gap if a function of the welding process employed, the composition of the work pieces, and the construction specifications. For establishing and containing the joint gap within requirements, clamping devices are employed, which in the optimal case keep the joint gap in the area of the welding location as small as possible.

A fixed or stationary clamping technique with non-moving fixing and clamping elements for use in the welding of work pieces is known. A multitude of clamping element sites ensures the necessary joint gap at each individual joint location as required for a laser welding process. This type of fixing and clamping elements are tailored specifically for a component, are complicated, expensive and inflexible. Due to the large number of clamping elements there are many sources of possible faults, so that it is more difficult to maintain control over such a welding process. If work pieces are simultaneously clamped in all locations, then a static redundancy results. Further, for containing the static redundancy, high clamping forces are necessary.

Further, accompanying or, as the case may be, traveling clamping systems are known, which are moved over the component to be joined using robots, and of which the clamping elements locally ensure that the joint size is as necessary for the welding process. Distinctions are made herein between one-sided clamping systems with a simple pressure roller or a pressure finger and two-sided clamping systems, for example with a double roller. In the one-sided system a counter-bearing in the form of a device or a constructive counter bearing is necessary. Systems acting on both sides of the work piece are flexible in their area of employment, since the counter bearing can be moved along directly with the clamping technical apparatus. The problem with all these systems is the controlling or containment of the joint gap with increasing distance from the clamping location. For example, in the welding of sheets, the further one is from the clamping location the less control one has over the gap geometry and the greater the resulting gap clearance due to the widening of the sheets.

Known clamping systems with clamping roller s have construction dictated limitations in the accessibility of welding tools at a welding location. The roller diameter herein has an interfering contour. When welding behind a roller the welding location is so far removed from the clamping location that a verifiable welding process can no longer be reliably ensured due to uncontrollable widening of the joint cap. In order to weld as close as possible to the clamping location, the welding tool in the case of the use of clamping roller s is employed beside, and not behind, a roller. The welding beside the roller requires a sufficient breadth of the joint flange at the work pieces, in order to be able to guide the roller and to form a welding seam. It is difficult for the roller to control the joint gap beside the roller with increasing distance from the roller, which makes impossible a process of reliable welding of geometric welding patterns, such as for example circular seams. Dash seams can, among other things, for this reason not be welded transversely, but rather only longitudinal to the direction of movement beside the roller.

Clamping systems with clamping fingers allow welding trailing behind in the direction of movement, that is, the welding location lies behind the clamping point. In comparison to clamping roller s, clamping fingers have the advantage that small flange breadths can be realized and tighter radiuses can be maneuvered around (by the welder). Further, when welding behind a clamping finger, one can weld close to the clamping point, since there is no interfering roller diameter to interfere with accessibility.

A disadvantage in the employment of clamping fingers is the difficult to control, and hardly to be guaranteed, joint gap relationships or behavior with increasing distancing from the clamping point. Clamping fingers are particularly advantageously employed in laser beam welding devices with conventional beam guidance. In these devices the laser beam is always held a constant distance from the clamping point during welding with a robot, wherein the robot movement speed is the same as the welding speed.

In laser welding processes with specific engagement in the beam positioning by beam deflection or steering systems, the laser beam, during welding of geometric patterns, is not maintained at a constant distance from the clamping point, and accordingly the robot speed of advance is not equal to the welding speed. The produced geometric seam pattern, for example in the form of circles, ovals or brackets, have a planer design, so that they extend into zones further removed from the clamping point, and for this the permissible joint gap must be maintained. A further disadvantage of purely finger clamping systems is the application of force upon a work piece to be joined respectively due to the friction between the clamping finger and the work piece. This disadvantage occurs above all in work pieces which require greater clamping forces and in which the clamping forces are built up locally upon a joint location, wherein during a robot movement the clamping fingers are removed from the respective work piece. Further, clamping fingers cause grooves and scratch marks, which compromise or preclude a visual presentability of a joint location.

From DE19501869C1 a device for welding of work pieces with laser beams is known, in which for the gap free guidance of the work piece two roller pairs are provided in equal separation respectively ahead of and behind of the welding location. The roller s have a closed and structured surface. The area of the welding location is additionally acted upon by a pressure plate and a slide block. For allowing the passage through of laser beams, the pressure plate has a conical aperture opening. This device is voluminous, elaborate and expensive and limited in its employability.

### SUMMARY OF THE INVENTION

It is the task of the invention to develop a device for processing work pieces, of which the clamping technique allows a high working quality and, with respect to the work piece geometry, makes possible a high flexibility in processing.

The task is solved with a device having the characteristics of Claim 1. Advantageous embodiments are set forth in the dependent claims.

According to the invention, a clamping technique is employed during processing, which includes a combination of at least one clamping finger and at least one clamping roller. The term “processing” in the sense of the invention includes all processes which require the clamping of one or more work pieces during joining by welding, soldering or adhering, during separating or trimming, during coating, during shaping or during changing of the material characteristics.

By the appropriate design and arrangement of the clamping fingers and the clamping roller, joint gaps can be produced and maintained between the work pieces over a large surface area. The geometry of the joint gap can be well controlled. The invention unites the advantages of clamp finger and clamp roller, so that there is free access for a tool at a processing location, in particular in the area exposed to view no scratch and/or marking of the clamp finger occurs upon the work piece and only small force applications need be applied to the work piece to be processed. Therewith there results, during use of this accompanying or traveling clamping system, an improved controllability of joint gaps over relatively large surfaces.

Particularly in laser welding with precise employment of the beam positioning by beam deflection systems, there results in accordance with the invention, as a result of the large surface area controllable joint gap, new possibilities in the realization of geometric seam patterns in combination with flexible clamping systems. The flexible clamping possibilities are also present in laser welding with conventional processing optics or lenses, that is, even without beam deflection.

The invention makes it possible to control a joint gap locally at a joint location better than with conventional accompanying solutions. The invention further makes possible the realization of light weight or simplified construction techniques, such as for example reduced flange breadth on body parts. The inventive clamping process is not limited to flanges but is applicable to the entire work piece. Thereby there results a high flexibility with regard to the possible variability of the target component. Particularly in the provision of planar or flat processing patterns there results in the employment of the invention a good accessibility of the welding tool to a clamping point from different directions. Welding patterns spreading out geometrically in a plane, such as circles, ovals or brackets, require in comparison to conventional, for example conventional processing lens produced dash seams, a more flat controlling of the joint gap. In particular in welding processes, with specific or targeted intervention in the beam positioning of the laser beam, the results, due to the flexible clamping, new possibilities to carry out the welding process. Further, with the invention it is possible to minimize imprints from the clamping elements on one of the two work piece surfaces, in particular component surfaces intended to be visible.

### BRIEF DESCRIPTION OF THE DRAWINGS

The invention will be described in greater detail in the following on the basis of the illustrative embodiment, wherein there is shown:

FIG. 1 a schematic of a clamping device with a clamping finger and a clamping roller,

FIG. 2-7 embodiments of clamping roller s,

FIG. 7-10 embodiments of clamp fingers,

FIG. 11 a schematic of a clamping device without offset of the clamp locations,

FIG. 12 a schematic of a clamping device with offset of the clamping locations,

FIG. 13-16 examples of use for clamping device to produce through-going weld seam,

FIG. 17-20 examples of use for clamping device with production of welded in seam in the area of a clamping roller

FIG. 21-27 a schematic for carrying out a sheet joining welding

FIG. 28-29 an example of use for the compelling of off-gas pockets, and

FIG. 30-31 a schematic of a clamping device with a supplemental clamping element.

### DETAILED DESCRIPTION OF THE INVENTION

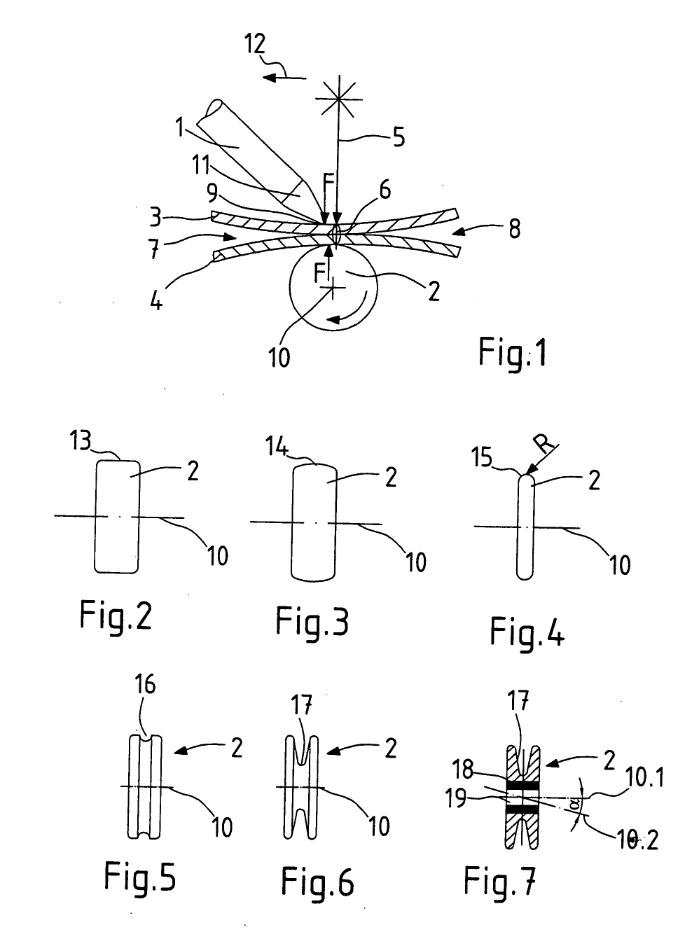

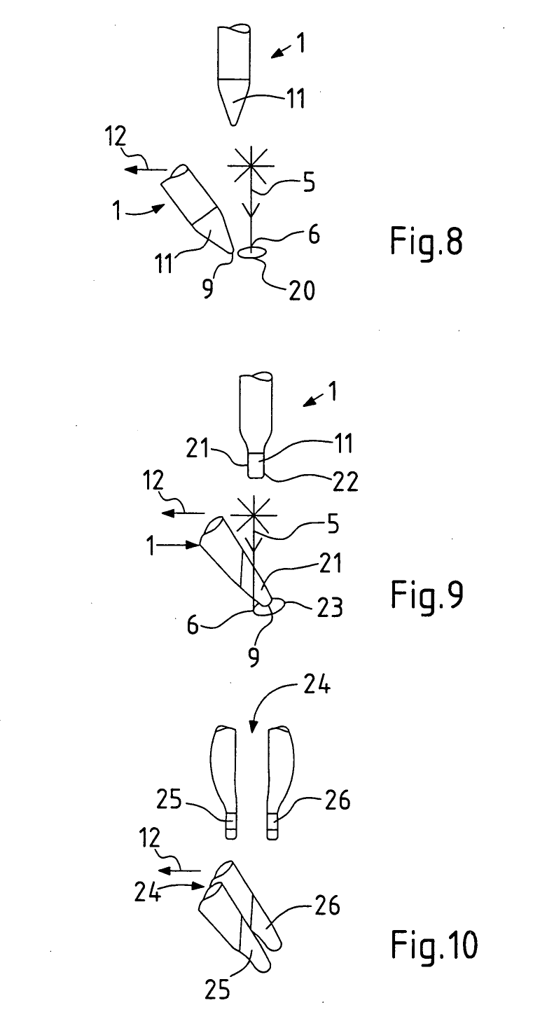

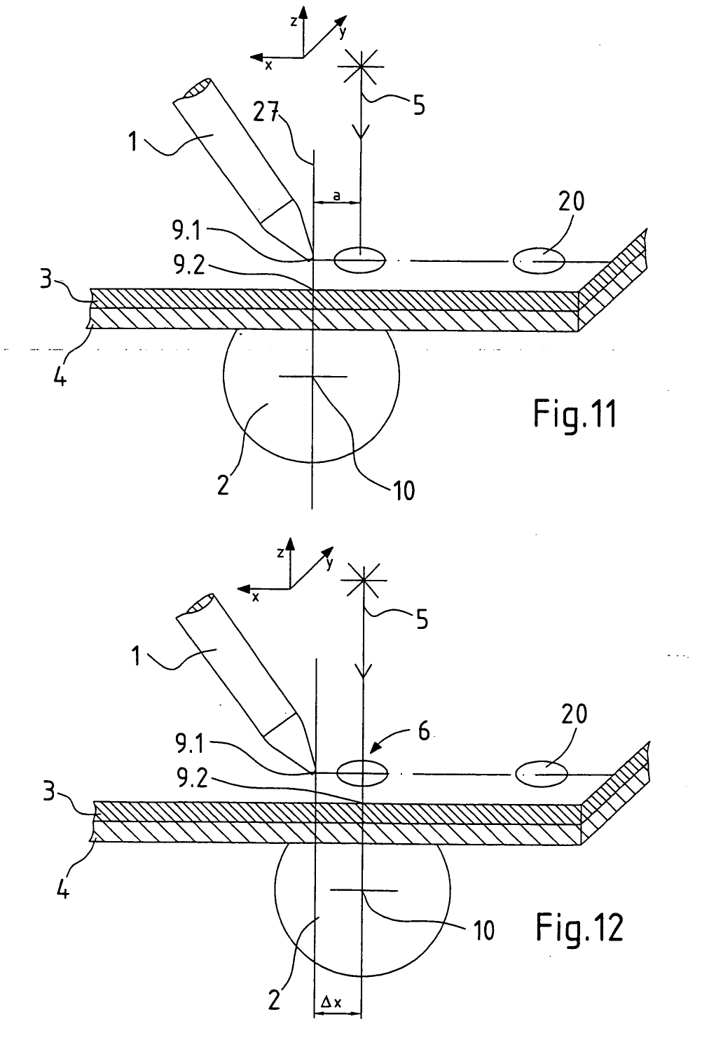

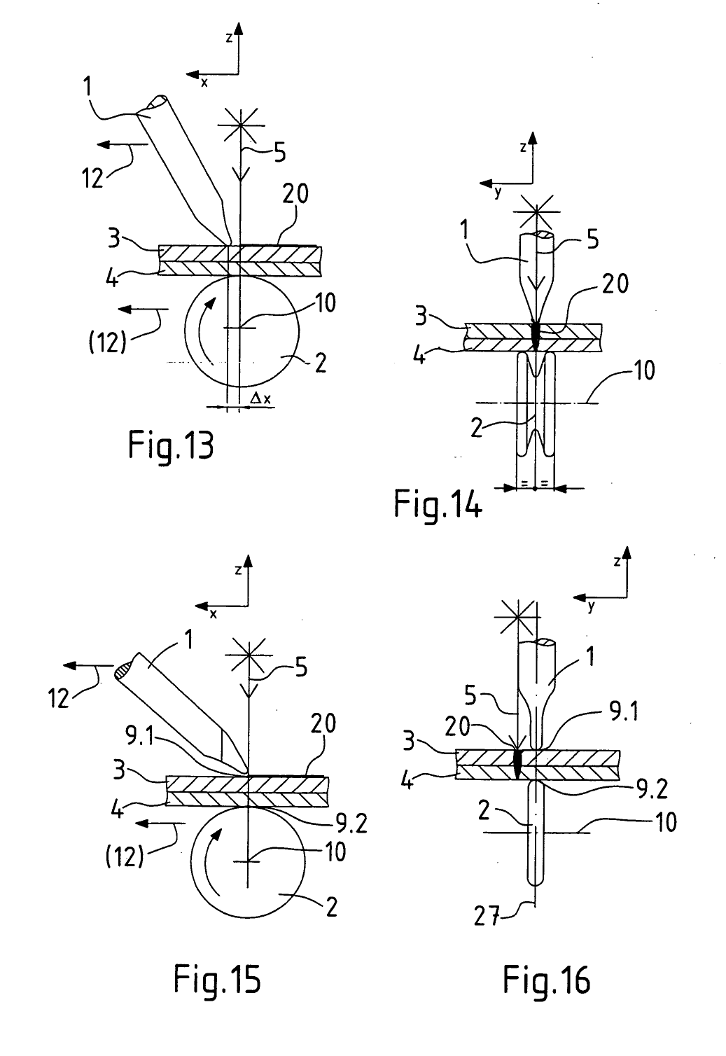

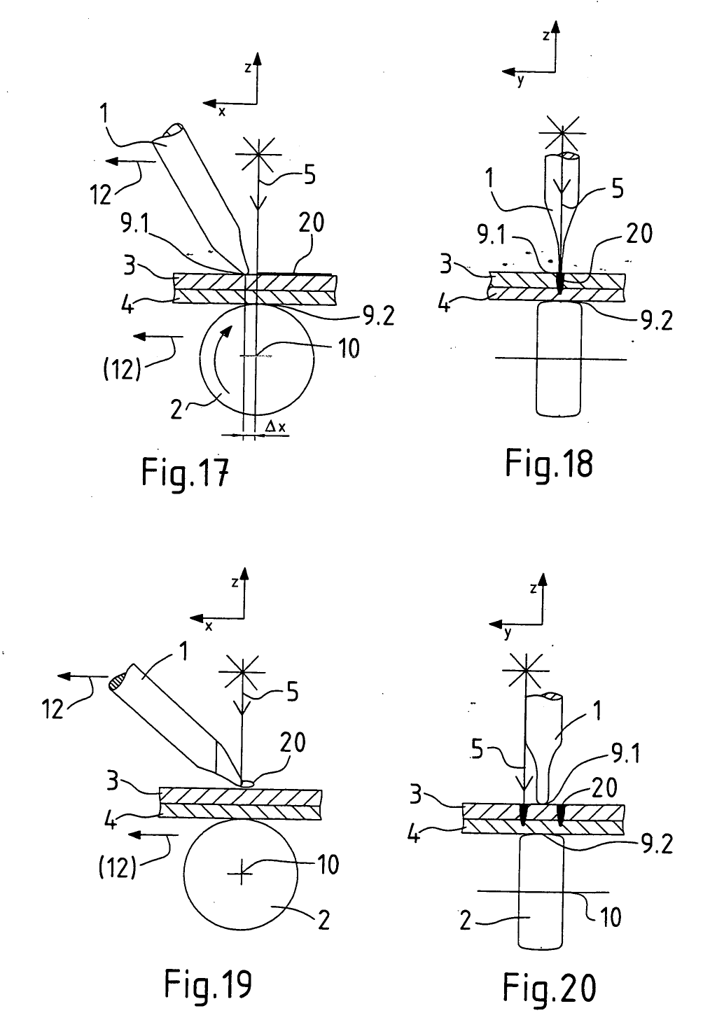

FIG. 1 shows a principle schematic of a clamping device with a clamping finger 1 and a clamping roller 2 for clamping of two sheets 3, 4 during welding with a laser beam 5. The laser beam 5 impinges perpendicularly upon the surface of the sheet 3. The clamping device is activated or operated, that means, clamp fingers 1 and clamping roller 2 are positioned against the sheets 3, 4 and they exercise upon the sheets 3, 4 a clamping force, which presses together the sheets 3, 4 at the welding location 6. On the welding location 6 the sheets 3, 4 lie tight against each other. In the absence of the effect of the clamping force gaps 7, 8 exists between the sheets 3, 4 outside of the welding location 6. The clamping device, inclusive of actuating process, can be provided on an arm of a robot, or in the clamping finger 1 and the clamping roller 2 can be applied and retracted for moving of the clamping location 9 to clamping location 9 on the sheets 3, 4. The movement of clamping position 9 to clamping position 9 can also occur with maintenance of the clamping force, wherein the clamping roller 6 rolls about its axis 10 upon the surface of the sheet 4 and the clamping finger 1 slides along the surface of the sheet 3. The tip 11 of the clamping finger 1 is hemispherically or convexly shaped in the vicinity of the welding location 6. The clamping finger 1 is seated diagonally at the clamping location 9 in the welding direction 12 upon the surface of the sheet 3. This makes it possible to place welding seams close to the clamping location 9. For producing special seam patterns the laser beam 5 can be brought to act in the environment of the clamping location 9 by a deflection device.

To the extent that already mentioned reference numbers are employed in the following description, these would concern elements with equivalent function.

Clamping roller 2 and clamping finger 1 are adapted to the welding process and the respective work piece. Therein various combinations of clamping finger 1 and clamping roller 2 are possible.

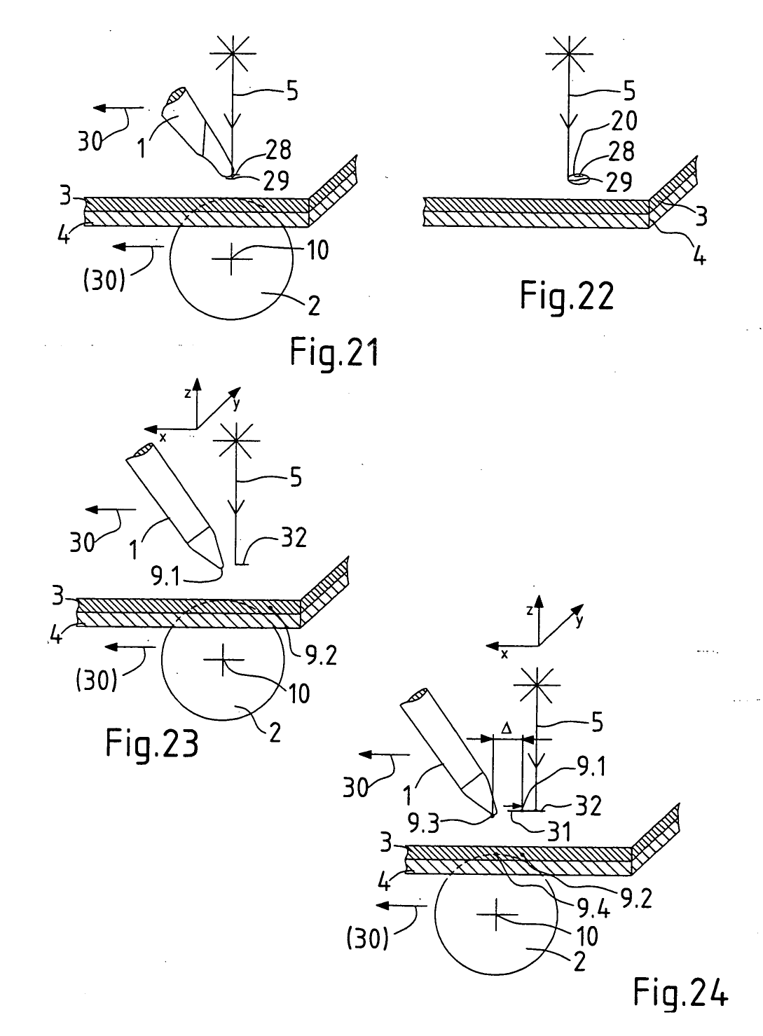

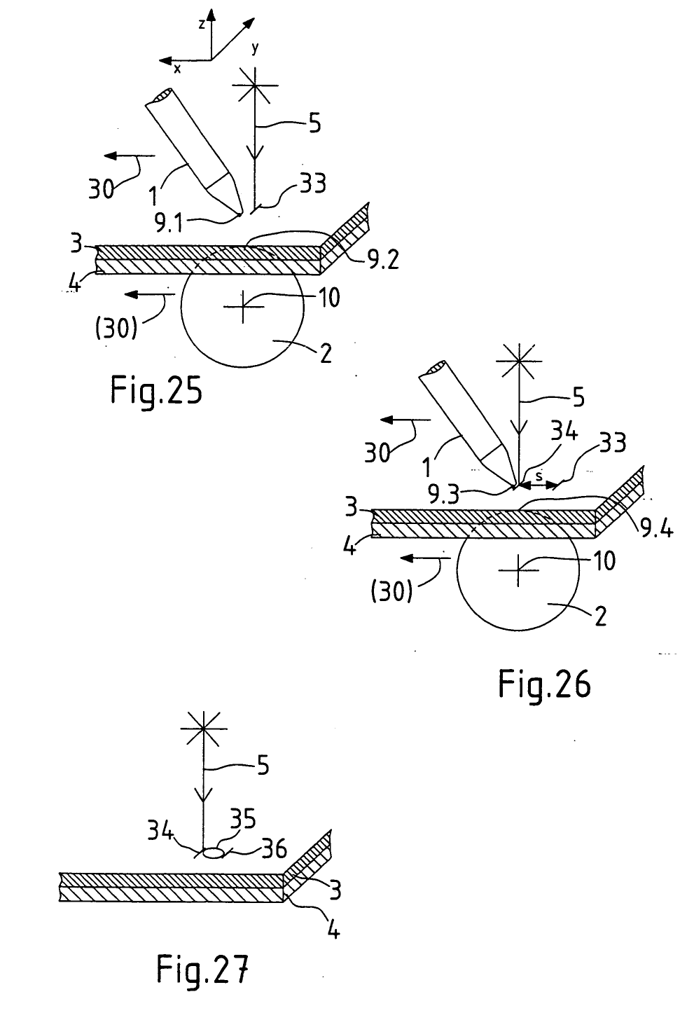

FIGS. 2-7 show multiple possible embodiments of clamping rollers 2. The clamping rollers 2 according to FIGS. 2 and 3 have, in their profile or tread, a planar or, as the case may be, convex running surface 13 and 14. The running surface 15 of the clamping roller 2 according to FIG. 4 has a profile with a radius. In FIG. 5 a clamping roller 2 is shown with a furrow or narrow channel running symmetrically in the circumferential direction.

In the clamping roller 2 according to FIG. 6 a U-shaped circumferential groove 17 is symmetrically introduced. During welding through of work pieces the groove 17 bridges over the weld seam, so that the clamping roller 2 does not interfere with the formation of the welding seam either by thermal extraction or by mechanical loading.

From its profile or cross section the clamping roller 2 according to FIG. 7 has the shape of the clamp roller 2 according to FIG. 6. In addition, the clamp roller 2 according to FIG. 7 has a core 18 of elastic material with a receptacle bore hole 19 for a mounting bolt. By the elastic mounting of the clamping roller 2 there results a slight possibility of yield, in order to counteract a one-sided load. The clamp roller 2 lies, in any case, against the work piece 4 at two points. Depending upon tilt or orientation of the clamping surface the orientation of the clamping roller 2 adapts thereto within the limits of the elasticity of the core 18, which is indicated symbolically by the angle α between the axis 10.1 and 10.2.

FIGS. 8-10 respectively show in profile and in employment multiple embodiments of clamping fingers 1, which can be varied in form, material, coating, number and positioning.

The clamping finger 1 applied diagonally against a work piece according to FIG. 8 is rotation symmetric with a conically narrowing tip 11. Close to a clamping location 9 on the work piece a closed circular shaped welding seam 20 is produced with a laser beam 5.

The clamping finger 1 according to FIG. 9 has on its tip 11 a profile with two flat parts 21, 22. During clamping, the clamp finger 1 is seated diagonally upon the work piece surface, as a result of which the flat parts 21, 22 lie in the direction of a laser beam 5. As a result the clamping finger 1 shows its narrow side in the direction of the laser beam 5, so that it is possible to form a bow-shaped welding seam 23 very close to a clamping location 9.

The clamping finger 1 can remain at the clamping location 9 during welding or may be moved. In the moving operation the bow-shaped welding seam 23 can be closed to form a circular seam.

FIG. 10 shows a pliers-shaped double finger 24 respectively with flattened fingertips 25, 26. During the welding process the fingertips 25, 26 are simultaneously seated upon the work piece surface diagonally and arranged parallel. The double finger 24 is equipped with a movement balancing perpendicular to the work piece surface. In case the double finger 24 is seated diagonally upon the work piece surface, the work piece lies diagonally or is non-planar, it is insured by the movement balancing or compensation that always both fingertips 25, 26 contribute to clamping. In cooperation with a clamping roller 2 three pressure points are established on the work pieces 3, 4, whereby an optimal clamping force introduction results.

A clamping finger 1 can be provided to be adjustable with regard to its angle of tilt relative to the work piece surface. The possibility of tilting a clamping finger 1 in various angles to a work piece exists in particular in the processing direction or as the case may be robot direction of movement and transverse thereto.

Depending upon combination of clamping finger 1, clamping roller 2, desired welding seam shape, welding seam type and work piece geometry, there results the possibility to displace the pressure points of clamping finger 1 and clamping roller 2 relative to each other, as shown in great detail in FIGS. 11 and 12.

According to FIG. 11, the pressure points 9.1 and 9.2 of clamping finger 1 and clamping roller 2 exhibit no offset in the robot movement direction x and in direction y transverse to the robot movement direction. The pressure points 9.1 and 9.2 lie on a joining or fusing line 27, which is perpendicular to the directions x, y and parallel to direction z. The work pieces 3, 4 lie in a plane parallel to the x-y-plane. The laser beam 5 impinges perpendicular upon the surface of the work piece 3, wherein for production of a circular shaped weld seam 20 the laser beam 5 exhibits a small space or a separation from the connecting line 27.

In distinction to FIG. 11 the welding device according to FIG. 12 exhibits at the pressure points 9.1 and 9.2 a displacement delta x in the robot movement direction x. The pressure points 9.2 of the clamp roller 2 lie in the z-direction below the welding location 6. The clamping roller 2 has a design according to FIG. 6 or 7.

The displacability of clamping fingers 1 and/or clamping roller 2 can be in all coordinate directions x, y, z. Thereby multi-faceted employment possibilities are provided for production of highly controllable gap relationships. It is possible to detect the gap condition or proportion by measurement techniques and to control or regulate the position of the clamp finger 1 and clamp roller 2 during welding relative to each other. Depending upon the combination of clamp finger 1 and clamp roller 2 and their arrangement relative to each other, it is possible to produce a planar seam pattern, such as circles, ovals or brackets, with a system deflecting a laser beam 5, as well as also simple seams with conventional processing optics.

FIGS. 13-16 show two illustrative embodiments for clamping devices with producing welded-through seams 20 respectively in two views.

In the variants according to FIGS. 13 and 14, clamp finger 1, clamp roller 2 and laser beam 5 are simultaneously moved in the welding direction 12, whereby a dash or line seam 20 is formed. The laser beam 5 brings about a welding-through of the two sheets 3, 4. The clamp roller 2, as best described in the text in association with FIG. 6, is provided with a circumferential groove 17. The groove 17 lies in the z-direction symmetric to the dash or line seam 20, so that the clamp roller 2 does not interfere with the formation of the dash or line seam 20 on the lower side of the sheet 4. The axis 10 of the clamp roller 2 lies parallel to the y-direction.

In the variant according to FIGS. 15 and 16 the clamp finger 1 and clamp roller 2 have no offset in the x-direction. The clamp finger 1 has a narrow shape, as described in the text in association with FIG. 9. The clamp roller 2 is a narrow embodiment with a radius according to FIG. 4. As can be seen from FIG. 15, the laser beam 5 lies in the x-direction on the height or level of the pressure point 9.1 and 9.2 of clamp finger 1 and clamp roller 2 on the two sheets 3, 4. As can be seen from FIG. 16, the laser beam 5 impinges in the y-direction close beside the clamp finger 1 or, as the case may be, beside the connecting line 27 of the two pressure points 9.1, 9.2.

FIGS. 17-20 show two applications of clamp devices during production of welded-in seams 20 respectively in two views.

In the variation according to FIGS. 17 and 18 the clamp finger 1 and clamp roller 2 have the geometry described in association with FIG. 12. In distinction to the variation according to FIGS. 13, 14, here a welded-in seam 20 is produced, in which the material of the sheet 4 is molten to about one half of the sheet thickness. As clamp roller 2 a spherical embodiment according to FIG. 3 is employed. Of course, another design of clamp roller 2 can be employed.

In the embodiment according to FIG. 19, 20 a circular shaped seam 20 is produced as a welded-in seam 20. In distinction to the embodiment according to FIGS. 15, 16, here a clamp roller 2 is employed, which provides or offers a pressure line 9.2 below the sheet 4. The projection of the pressure point 9.1 halves or divides the pressure line 9.2. During the formation of the circular shape seam 20 the laser beam 5 is guided with a deflection system close about the pressure point 9.1.

The invention can advantageously be employed in clamping welding processes, as described in greater detail on the basis of FIGS. 21-27. The clamp welding operation is preferably carried out with welding devices, in which a laser beam 5 is positioned by beam deflection units and a scanner system. In the case of production of geometric seam patterns such as circles, ovals or brackets, it is necessary for the welding process to ensure an optimal joint gap over a large surface area. In the operating condition of the clamping device, first tack seams are made very close to a clamp point, whereby small joint gaps result, which can be controlled or checked over a large surface area. The joining seam or tack seam fixes the work pieces to be joined to each other and locally freezes the joint gap. Thereafter the actual weld seam is produced. When carrying out the final weld seam a clamping of the work piece in the area of the weld seam is no longer necessary. Clamp finger 1 and clamp roller 2 can already be moved to the next joint location during the carrying out of the actual welding process in order to affect there a clamping process for a further clamp welding process. The clamp seams can differ in their embodiment shape, in particular with respect to position on the work piece, shape, type and number, depending upon combination of clamp finger 1 and clamp roller 2 and their orientation or positioning relative to each other.

FIG. 21 shows a clamping situation with a clamp finger 1 and a clamp roller 2 in an arrangement according to FIG. 15, 16 or 19, 20. First, with a laser beam 5, a clamping or holding seam or two short clamping seams or tack seams 28, 29 are produced for the joining close beside a flat clamp finger 1. Thereafter clamp finger 1 and clamp roller 2 are moved together in the direction of the arrow 30 to the next clamp location and repositioned. The sheets 3, 4 remain fixed in their spacing to each other at the location of the tack seams 28, 29. As shown in FIG. 22, then the final weld seam 20 can be produced. In the illustrated case a circular shaped weld seam 20 is produced around the tack seams 28, 29.

The embodiment according to FIG. 23, 24 shows the production of a dash or line seam 31 with a preceding tack seam 32. The clamping device has the design according to FIG. 13, 14 or 17, 18. After the sheets 3, 4 are pressed against each other with the clamp finger 1 and a clamp roller 2 at the clamp location 9.1 and 9.2, first a short dash-shape tack seam 32 is formed in the direction x. Thereafter the clamp finger 1 and clamp roller 2 are moved in the x-direction about the path s, as indicated with the arrows 30, respectively to the next clamp location 9.3 and 9.4 and there are actuated for clamping. This situation is shown in FIG. 24. Subsequently the laser beam 5 executes, beginning from the immediate vicinity of clamp location 9.3, in the direction of clamp location 9.1, a line seam 20, which passes over tack seam 31. Thereafter, clamp finger 1 and clamp roller 2 are again displaced about path s in the x-direction to the next clamp location and a new line seam with advance or preceding tack seam is put in place. These processes are repeated until the seam line 31 is produced step-wise over the intended joint length.

In FIGS. 25-27 a further example for the carrying out of the welding process with joining welding is shown. The clamp device has the configuration described in FIG. 13, 14 or 17, 18. In a first step, with actuated clamping device, a short line shaped tack seam 33 is produced with a laser beam 5, as shown in FIG. 25. The tack seam 33 lies directly ahead of the clamp point 9.1 of clamp finger 1 and extends transverse to the direction of advance 30 of the clamp finger 1 or, as the case may be, clamp roller 2, in the y-direction. In a next step clamp finger 1 and clamp roller 2 are displaced about the path s in the y-direction and actuated for clamping of the clamp points 9.3, 9.4. In a further step again a tack seam 34 is produced directly ahead of the clamp point 9.3. The tacks seams 33, 34 likewise have the spacing s as shown in FIG. 26. In a next step clamp finger 1 and clamp roller 2 are together guided along path s to the next clamp location. As shown in FIG. 27, in a next step a final square seam 35 is produced between the previously produced tack seams 33, 34. The welded-out seam 35 could be circular shaped, oval or likewise be in the form of a bracket. Subsequently a tack seam is renewed produced at the next clamp location. These steps are repeated over the length of the joint of the sheets 3, 4.

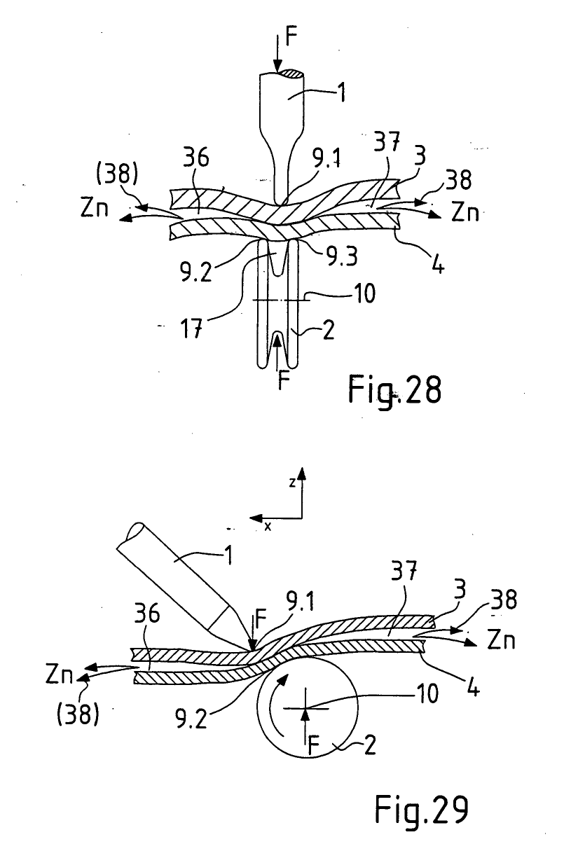

During welding of sheets with low melting coatings, such as for example zinced sheets, it can be necessary to provide off-gassing possibilities. If the distance between the sheets is almost zero and the coating or, as the case may be, zinc is caused to evaporate explosively, than this leads to a throwing out of melt pool material and therewith to faulty weld seams. The invention makes it possible to exercise influence upon the off-gassing behavior, by the targeted production of off-gassing pockets. For this, the clamp devices can be provided or equipped with a path control for clamp finger 1 and/or clamp roller 2. Therein an off-gas gap can be predetermined and the desired total sheet thickness can be added up. A further possibility is comprised therein, to intentionally produce corrugations in the sheet metal using clamping forces, as illustrated in greater detail in FIGS. 28, 29.

FIG. 28 shows a clamp device with a clamp finger 1 and clamp roller 2. The clamp finger 1 corresponds to the embodiment according to FIG. 9 and the clamp roller to the embodiment according to FIG. 6. Shown is the clamp device with view upon the direction of movement of the clamp roller 2. The projection of the contact point 9.1 of the clamp finger 1 upon the sheet 3 lies exactly between the contact or application points 9.2, 9.3 of the clamp roller 2 upon the sheet 4. The clamp finger 1 and the clamp roller 2 act respectively with a force against the sheets 3, 4, so that the sheets 3, 4 are deformed. The sheets 3, 4 are pressed into the groove 4 of clamp roller 2, whereby the sheets 3, 4 in the elastic region are variously strongly bent or bowed. Thereby, off-gas gaps 36, 37 result between the sheets 3, 4, so that zinc vapor 38 can escape.

In FIG. 29 a clamp device with a clamp finger 1 and clamp roller 2 is illustrated in side view. If clamp force F acts in the x-direction upon two superimposed lying sheets 3, 4 with offset lines of action to each other in the direction z, then the sheets 3, 4 are subject to shear, and deform in the elastic area, so that off-gas gaps 36, 37 result, from which zinc vapor 38 can escape.

In a further embodiment of the invention active or passive clamp elements can be provided supplementally to the clamp finger 1 and clamp roller 2. This supplemental clamp element preferably act by following the weld position and can be provided one-sided or two sided on the work pieces 3, 4. As supplemental clamping elements there can, depending upon application, be employed roller or fingers. The pressure force of the supplemental clamp elements can be applied with springs, which are activated during closing of a main clamp device containing the clamp finger 1 and clamp roller 2, via a mechanism. The supplemental clamping elements serve to improve the joint gap control during difficult clamping situations, in starting points on the work pieces 3, 4, or in the case of greatly spaced apart joining points.

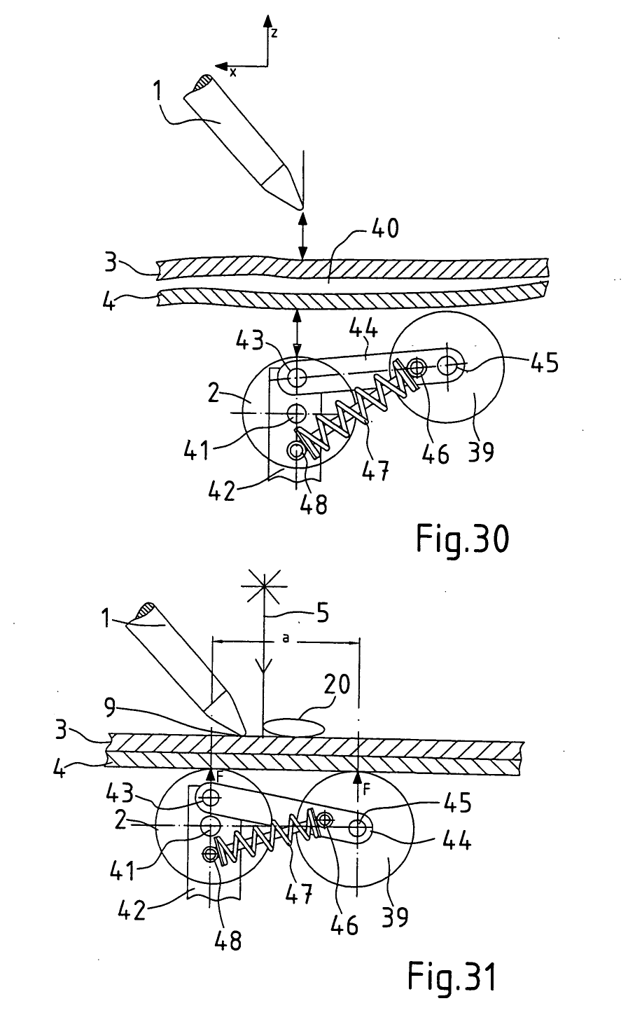

In FIG. 30-31 the employment of a supplemental assist clamp roller 39 is shown in a main clamp device comprising a clamp finger 1 and clamp roller 2 in the opened and closed positions.

In the open position according to FIG. 30 the clamp finger 1 and clamp roller 2 are withdrawn from the sheets 3, 4. Between the sheets 3, 4 there is still a gap 40. The clamp roller 2 is rotatably mounted on a mount 42 via a bolt 41. In an extension of the mount 42 a bar 44 is pivotably held via a pin 43. On the other end of the bar 43 an assist clamp roller 39 is rotatably mounted via a bolt 45. In the vicinity of the bolt 45 there is on the bar 44 a bolt 46, on the one end of which a spring 47 is secured. The other end of the spring 47 is secured to a bolt 48 on the mount 42. By the force of the spring 47 in the non-operating condition of the main clamp device the assist roller 39 is held on a z-level higher than the clamp roller 2. The spring 47 can be provided with an adjustable pretensioning.

Upon closing of the main clamp device the clamp finger 1 and the clamp roller 2 inclusive of the assist clamp roller 39 are moved toward each other in the z-direction. Due to the higher level of the assist clamp roller 34 this contacts the lower side of the sheet 4 first, whereupon the spring 47 is compressed. The sheets 3, 4 come closer together, so that the gap 40 disappears. Finally the clamp roller 2 also contacts the lower side of the sheet 4. In the condition shown in FIG. 31 there are applied, on the one hand, the main clamp forces F between the clamp finger 1 and clamp roller 2 and, on the other hand, the assist clamp force due to compression of the spring 47. During application of the clamp roller 2 against the lower side of the sheet 4 the assist clamp roller 39 is pivoted against the bias of the spring force about bolt 43. Therewith the spring 47 urges the assist clamp roller 39 against the lower side of the sheet 4 with a z-component F_{F}. The direction of action of the clamp forces F and F_{F} of the main clamp roller 2 and the assist clamp roller 39 in the z-direction lie offset by a distance or separation “a” in the x-direction. The line of action or effect of the clamp force F of the clamp finger 1 in the z-direction lies between the effect lines of clamp forces of clamp roller 2 and assist clamp roller 39 close to the clamp roller 2. In the operating condition of the clamp device a planar seam 20 can be created in the vicinity of clamp location 9 of clamp finger 1 by a laser beam 5.

The clamp force of a clamp device can be produced with electromechanical elements, in particular a screw link actuator, as well as pneumatic or hydraulic elements. In order to avoid a piling up of folds of the sheet and to avoid unnecessary finger or, as the case may be, roller prints upon the work piece, the clamp force necessary for the clamping process need be built up only at the actual joint location. Traveling up to the next joint location, the clamp force is reduced or removed from the work piece.

When a laser weld robot is employed, then the clamp device can be moved along on an arm together with the processing optics. In a further variation the clamp device can be mounted on an arm of a separate clamp robot. Further, the clamp device can be provided stationary together with a laser optic, wherein the work pieces are is moved through the clamp device, for example with the aid of an industrial robot.

### LIST OF REFERENCE NUMBERS

1 Clamp Finger
2 Clamp Roll
3, 4 Sheet
5 Laser Beam
6 Weld Location
7, 8 Gap
9 Tensioning or clamping location
10 Axis
11 Tip
12 Welding direction
13-14 Running surface
16 Groove
17 Channel or groove
18 Core
19 Receptacle bore hole
20 Weld seam
21, 22 Flat part
23 Weld seam
24 Double finger
25, 26 Fingertip
27 Connecting line
28, 29 Tack seam
30 Arrow
31 Line seam
32-34 Tack seam
35 Seam
36, 37 Off-gas gap
38 Zinc vapor
39 Assist clamp roller
40 Gap
41 Bolt
42 Mount
43 Pin
44 Bar
45, 46 Bolt
47 Spring
48 Bolt

1. A clamping device for processing work pieces, with at least one first clamp element and at least one second clamp element, adapted to holding between them at least one work piece, wherein a tool is movable relative to the work piece, wherein the first clamp element is a clamp finger (1, 24) adapted to moving along with the process and acting on the side of the work piece (3, 4) upon which the tool (5) acts upon the work piece (3, 4), and wherein the second clamp element is a traveling clamp roller (2) acting against the side of the work piece (4) opposite to the tool (5).

2. The clamping device according to claim 1, said device adapted to cooperating with a laser beam for laser welding, wherein during joining of flat work pieces (3, 4) by laser beam welding, a clamp force (F) exists between a clamp finger (1, 24) and a clamp roller (2), and wherein the welding location (6) lies in close proximity to the clamp location (9) of the clamp finger (1, 24).

3. The clamping device according to claim 1, wherein the clamp finger (1, 24) exhibits at the end a narrow profile at the clamp location (9) when viewed in the beam direction of the laser beam (5).

4. The clamping device according to claim 1, wherein the clamp finger is a double finger (24), wherein between the fingers an aperture exists through which a laser beam (5) can pass.

5. The clamping device according to claim 4, wherein the fingers have a movement compensation relative to each other in the clamp direction.

6. The clamping device according to claim 1, wherein the clamp roller (2) exhibits a profile with a groove (17) in the running surface, in which case the weld seam (9) can be formed during welding between the walls of the groove (17).

7. The clamping device according to claim 1, wherein the tilt of the clamp finger (1, 24) to the surface of the work piece (3) is adjustable.

8. The clamping device according to claim 1, wherein the clamp roller (2) includes a mounting element (18) with axial compensation ability.

9. The clamping device according to claim 1, wherein the clamp location (9) of the clamp finger (1) is adjustable relative to the clamp location (9) of the clamp roller (2).

10. The clamping device according to claim 1, wherein for achieving a predetermined gap between two flat work pieces the position of the clamp fingers (1, 24) relative to the clamp roller (2) is adjustable.

11. The clamping device according to claim 10, wherein a sensor is provided for measuring the gap width.

12. The clamping device according to claim 1, wherein additional clamp elements (39) are provided, which can be applied against a work piece (4) together with the clamp finger (1, 24) and/or the clamp roller (2), wherein the supplemental clamp elements (39) follow the tool (5) in the processing direction (12) of the work tool.

13. The clamping device according to claim 12, wherein as supplemental clamp element at least one further clamp roller (39) is provided.

14. The clamping device according to claim 13, wherein the clamp roller (2, 39) is connected with a coupling element (44), wherein the supplemental clamp roller (39) is supported via a pressure spring (47) against the mount (42) of the first clamp roller (2).

15. The clamping device according to claim 13, wherein, in the case that the clamp rollers (2, 39) are lifted from the work piece (4), the supplemental clamp roller (39) lies closer to the work piece (4) than the first clamp roller (2).
